(19) United States
(12) Patent Application Publication
(10) Pub. No.: US 2004/0209073 A1
(43) Pub. Date: Oct. 21, 2004

(54) Biodegradable biaxially drawn film with controlled tear resistance

(76) Inventors: Sonja Rosenbaum, Bous (DE); Marlies Rosenbaum, Bous (DE); Manfred Rosenbaum, Bous (DE); Detlef Busch, Saarlouis (DE)

Correspondence Address: CONNOLLY BOVE LODGE & HUTZ, LLP, P O BOX 2207, WILMINGTON, DE, 19899, US

(21) Appl. No.: 10/479,640

(22) PCT Filed: May 31, 2002
(86) PCT No.: PCT/EP02/05947

(30) Foreign Application Priority Data
Jun. 6, 2001 (DE) 101 27 314.2

(51) Int. Cl. B32B 27/00

(52) U.S. Cl. 428/337

(57) ABSTRACT

The invention relates to a film with controllable tear resistant properties, comprising at least one basic layer which contains at least one polymer I from at least one hydroxycarboxylic acid, and >0.1 wt. %, in relation to the weight of the layer, of a thermoplastic polymer II which is different from polymer I, and/or inorganic additives.

The success of biaxially oriented plastic films, in particular films made from thermoplastic polymers, is essentially based on their excellent mechanical strength properties in combination with comparatively low weight, good barrier properties and good weldability. The film protects the pack contents against rapid drying-out and against loss of aroma on using a very small amount of material.

What stands in the way of the consumer's need for hygienic, visually appealing, tightly sealed and robust packaging is the desire for easy and controllable opening. The latter is increasingly the subject of consumer complaints in the case of packaging comprising polyolefin films and is regarded as a disadvantage compared with paper packaging.

Uniaxially oriented films, such as, for example, tape products, exhibit distinctly low initial tear strength and/or a high tendency to split in the orientation direction and can therefore readily be torn initially and torn further in a controlled manner in this direction. However, uniaxially oriented films are unsuitable for many areas, inter alia owing to deficient mechanical strength in the transverse direction.

The process of biaxial orientation generates on the one hand the desired high strengths (moduli) in both dimensions; on the other hand, however, the preferential directions are also partially levelled out as a consequence of the process. This has the consequence that, in order to open film packaging comprising a biaxially oriented film (for example cookie bags), a high force initially has to be overcome in order to tear the film. However, once the film has been damaged or partially torn, a tear propagates in an uncontrollable manner, even on application of very low tensile forces. These deficient service properties of excessively high initial tear strength and uncontrollable tear propagation behaviour reduce acceptance of film packaging in the end consumer market, in spite of the advantages mentioned at the outset.

In order to solve this problem, EP 0 781 652, for example, proposes the use of a peelable layer in combination with a special layer structure. This makes it possible to re-open the film packaging in a controlled manner where it was originally sealed, namely in the seam. This predetermined breaking point provided is intended to prevent tears propagating in the film in an uncontrolled manner during opening.

A further solution that has been proposed is a multilayered structure with a predetermined breaking point in the form of a layer which has particularly low mechanical strength. On opening, the film initially tears at this predetermined breaking point. The tear only propagates in the weak layer. This principle is implemented both in the case of coextruded films and in the case of multilayered laminates.

A further known potential solution is subsequent mechanical incorporation of a predetermined breaking point in the form of a perforation or notch or mechanical weakening by means of a laser, as a thermal process for partial, layer-wise removal of material, or displacement as a consequence of plastic deformation.

In other cases, a tear-open tape (usually polyester) is used in order to facilitate controlled opening of the packaging. This solution is very expensive and has therefore not become established everywhere on the market.

The uncontrolled tear propagation behaviour of biaxially oriented films is particularly disadvantageous in packaging containing piece products. Although the consumer would generally like to remove the packaged products piece by piece one after the other, cookies, jelly babies or potato crisps fall towards him in an uncontrolled manner after initial tearing. A similar problem arises in the case of piece products which are not packed loose, but instead in an ordered manner, such as, for example, in the case of cigarette cartons, Weetabix, crispbreads, cookie rolls and the like. These types of packaging are particularly aimed at the fact that the consumer would like initially to remove only individual pieces and would like to store the remainder in the packaging in order to remove further pieces at a later point in time. For this application, uncontrolled tear propagation of the film packaging is particularly annoying to the consumer.

There has therefore long been a need for a packaging material which exhibits controlled tear-open behaviour and is suitable for the manufacturers of consumer-friendly packaging.

Besides the service properties of packaging materials, their disposal and the raw-material sources are increasingly playing an important role. Recycling systems are being developed only slowly, have questionable effectiveness and are often implemented only regionally, for example in Germany. In addition, petroleum as the natural starting material for polyolefinic thermoplastics is limited. These circumstances result in the basic requirement for suitable packaging materials made from renewable raw materials which, in addition, can be disposed of in an environmentally friendly manner.

This need has resulted in the development of polymers whose production chain starts with renewable raw materials. Examples thereof are polymers and copolymers of lactic acids and other hydroxycarboxylic acids, referred to below as PLAs. These are hydrolysed slowly at a certain atmospheric humidity level and elevated temperature and ultimately decompose into water and CO₂. These polymers are therefore known as degradable polymers and can be produced from vegetable, renewable raw materials. PLAs are produced on a large industrial scale by ring-opening polymerization of a cyclic lactic acid dimer, which is known as lactide. Corresponding processes are known from the prior art and are described, for example, in U.S. Pat. No. 1,995,970 or U.S. Pat. No. 2,362,511.

Besides the raw materials per se, film products made from PLA are also known from the prior art. For example, U.S. Pat. No. 5,443,780 describes the production of oriented films from PLA. The process starts from a PLA melt, which is extruded and rapidly cooled. This pre-film can subsequently be subjected to a uniaxial stretching process or subjected to sequential or simultaneous biaxial stretching. The stretching temperature is between the glass transition temperature and the crystallization temperature of the PLA. The stretching produces increased strength and a higher Young's modulus in the final film. If desired, the stretching is followed by heat setting.

The object of the present invention was to provide a film which has controlled initial-tear and tear propagation behaviour.

This object is achieved by a biaxially stretched film which includes at least one base layer which comprises at least one polymer I comprising at least one hydroxycarboxylic acid and ≧0.2% by weight, based on the weight of the layer, of a thermoplastic polymer II which is different from the polymer I.

Furthermore, this object is achieved by a biaxially stretched film which includes at least one base layer which comprises at least one polymer I comprising at least one hydroxycarboxylic acid and ≧0.2% by weight, based on the weight of the layer, of an inorganic filler.

Further solutions to the object are indicated in the independent claims. The processes, uses and subject-matters of the dependent sub-claims are preferred embodiments of the invention.

In accordance with the invention, the biaxially oriented film includes at least one base layer: which comprises at least one polymer I comprising at least one hydroxycarboxylic acid and ≧0.2% by weight, based on the weight of the layer, of a thermoplastic polymer II which is different from the polymer I and/or inorganic. fillers. The base layer preferably comprises from 0.1 to 15% by weight of the polymer II and/or inorganic fillers, in particular from 0.5 to 10% by weight, in each case based on the base layer. With respect to compostability of the packaging, it is advantageous to keep the content of polymer II as low as possible. For compostable embodiments of this type, the amount of polymer II should be from 0.2 to 5% by weight, preferably from 0.2 to 3% by weight, based on the base layer.

It has been found that the addition of the thermoplastic polymer II described in greater detail below and/or the inorganic additives to the base layer significantly improves the tear behaviour of the biaxially stretched film comprising polyhydroxycarboxylic acid. It has been found that films comprising mixtures of this type in the base layer can be torn open in a very controlled manner. Without further assistants, such as mechanical weakening, perforation or stuck-on tear-open strips, it is possible to tear the film into thin strips along an imaginary line.

Packaging made from the film according to the invention can thus be opened as if a tear-open strip were present without one having been applied.

For the purposes of the present invention, the base layer of the film is taken to mean the layer which comprises at least one polymer I comprising at least one hydroxycarboxylic acid and ≧0.2% by weight, based on the weight of the layer, of a thermoplastic polymer II which is different from the polymer I and/or inorganic additives and which has the greatest layer thickness and makes up at least 40% of the total film thickness. In the case of single-layered embodiments, the film consists only of this base layer. In the case of multilayered embodiments, the film has additional top layers applied to this base layer and optionally additionally interlayers.

For the purposes of the present invention, the term “film” denotes both a single-layered film which consists only of this base layer and multilayered films which include the base layer and additional layers.

As part of the present invention, mention is made of polymers I comprising at least one hydroxycarboxylic acid “PHC” (polyhydroxycarboxylic acids). These are taken to mean homopolymers or copolymers built up from polymerized units of hydroxycarboxylic acids. Of the PHCs which are suitable for the present invention, polylactic acids are particularly suitable. These are referred to below as PLA (polylactide acid). Here too, the term is taken to mean both homopolymers built up only from lactic acid units and copolymers comprising predominantly lactic acid units (>50%) in combination with other comonomers, in particular other hydroxylactic acid units.

The film according to the invention exhibits the desired tear propagation behaviour both in the single-layered embodiment and as a multilayered embodiment. Multilayered films are generally built up from the base layer and at least one top layer. For the top layers, the mixtures of polymer I and II described for the base layer can in principle likewise be used. It is in principle also possible to apply top layers built up only from PHC. If desired, it is also possible to employ modified PLA raw materials in the top layer. The top layer(s) is/are applied either to the surface of the base layer or to the surface of any interlayer additionally present.

The base layer of the film generally comprises at least from 80 to 99.9% by weight, preferably from 85 to 99.5% by weight, in particular from 90 to <99.5% by weight, in each case based on the layer, of a polymer based on a hydroxycarboxylic acid and from 0.1 to 15% by weight, preferably from 0.5 to 10% by weight, in particular from 0.5 to 5% by weight, of a thermoplastic polymer II and/or inorganic additives, and optionally additionally conventional additives in effective amounts in each case.

Suitable monomers of the polymers based on hydroxycarboxylic acids are in particular mono-, di- or trihydroxycarboxylic acids or dimeric cyclic esters thereof, of which lactic acid in its D or L form is preferred. A particularly suitable PLA is polylactic acid from Cargill Dow (NatureWorks®). The preparation of this polylactic acid is disclosed in the prior art and is carried out by catalytic ring-opening polymerization of lactide (1,4-dioxane-3,6-dimethyl-2,5-dione), the dimeric cyclic ester of lactic acid, for which reason PLA is frequently also referred to as polylactide. The preparation of PLA is described in the following publications: U.S. Pat. No. 5,208,297, U.S. Pat. No. 5,247,058 and U.S. Pat. No. 5,357,035.

Preference is given to polylactic acids built up exclusively from lactic acid units. Particular preference is given here to PLA homopolymers comprising 80-100% by weight of L-lactic acid units, corresponding to from 0 to 20% by weight of D-lactic acid units. In order to reduce the crystallinity, it is also possible for even higher concentrations of D-lactic acid units to be present. If desired, the polylactic acid may comprise additional mono- or polyhydroxy acid units other than lactic acid as comonomer, for example glycolic acid units, 3-hydroxypropanoic acid units, 2,2-dimethyl-3-hydroxypropanoic acid units or higher homologues of hydroxycarboxylic acids having up to 5 carbon atoms.

Preference is given to lactic acid polymers having a melting point of from 110 to 170° C., preferably from 125 to 165° C., and a melt flow index (measurement DIN 53 735 at a load of 2.16 N and 190° C.) of from 1 to 50 g/10 min, preferably from 1 to 30 g/10 min. The molecular weight of the PLA is generally in a range from at least 10,000 to 500,000 (number average), preferably from 50,000 to 300,000 (number average). The glass transition temperature Tg is preferably in a range from 40 to 100° C., preferably from 40 to 80° C.

The thermoplastic polymers II which are added to the base layer improve the initial-tear and tear propagation behaviour of the film compared with films which have a base layer of PLA without these thermoplastic polymers. This advantageous action has been found, in particular, in mixtures of PHC, preferably PLA, and polypropylenes, mixtures of PHC, preferably PLA, and polyethylenes, and mixtures of PHC, preferably PLA, and polyesters.

Polypropylenes which are suitable for the mixtures are polymers which comprise at least 50% by weight of propylene units. Examples of suitable propylene polymers as thermoplastic polymer II are propylene homopolymers, copolymers of ethylene and propylene or propylene and 1-butylene or terpolymers of ethylene and propylene and 1-butylene, or a mixture or blend of two or more of the said homopolymers, copolymers and terpolymers.

Particularly suitable are random ethylene-propylene copolymers having an ethylene content of from 1 to 20% by weight, preferably from 2.5 to 10% by weight, or random propylene-1-butylene copolymers having a butylene content of from 2 to 25% by weight, preferably from 4 to 20% by weight, in each case based on the total weight of the copolymer, or

random ethylene-propylene-l-butylene terpolymers having an ethylene content of from 1 to 20% by weight, preferably from 2 to 6% by weight, and a 1-butylene content of from 2 to 20% by weight, preferably from 4 to 20% by weight, in each case based on the total weight of the terpolymer, or

a blend or mixture of an ethylene-propylene-1-butylene terpolymer and a propylene-1-butylene copolymer having an ethylene content of from 0.1 to 7% by weight and a propylene content of from 50 to 90% by weight and a 1-butylene content of from 10 to 40% by weight, in each case based on the total weight of the blend or mixture.

The suitable propylene copolymers and/or terpolymers described above generally have a melt flow index of from 1.5 to 30 g/10 min, preferably from 3 to 15 g/10 min. The melting point is in the range from 100 to 140° C. The above-described blend of propylene copolymers and terpolymers has a melt flow index of from 5 to 9 g/10 min and a melting point of from 100 to 150° C. All the melt flow indices indicated above are measured at 230° C. and a force of 21.6 N (DIN 53 735).

The suitable propylene homopolymers generally have a melt flow index of from 1.5 to 30 g/10 min, preferably from 3 to 15 g/10 min. The melting point of the homopolymers is in the range from 150 to 170° C., preferably from 155 to 165° C. Preference is given to isotactic propylene homopolymers whose isotacticity is greater than 92%, preferably in the range from 94 to 98%. The n-heptane-soluble content of the isotactic propylene homopolymers is less than 10% by weight, preferably from 1 to 8% by weight, based on the weight of the homopolymer. All the melt flow indices indicated above are measured at 230° C., and a force of 21.6 N (DIN 53735).

Polyethylenes which are suitable for the mixture basically include all homopolymers or copolymers' comprising predominantly, i.e. at least 50% by weight, preferably from 80 to 100% by weight, of ethylene units, for example LDPE, MDPE and HDPE.

For example, polyethylenes having a density in the range from 0.88 to 0.93 and a crystalline melting point in the range from 100 to 120° C. can be employed. The melt flow index is preferably from 0.1 to 10 g/10 min (190/2.16). Low-density polyethylenes of this type are known per se in the prior art as LDPE, LLDPE or VLPE. These low-density polyethylenes have molecular branches with side chains of various length and are therefore also known as branched polyethylenes.

High- and medium-density polyethylenes are likewise suitable as polymer II. Ethylene homopolymers and ethylene copolymers are likewise suitable here. These polymers generally have few and short side chains and correspondingly greater crystallinities. The degree of crystallization is in the range from 50 to 90%. The density for MDPE is from >0.93 to 0.945 g/cm³, the melt flow index (190/2.16) is from 0.1 to 1 g/10 min, and the crystalline melting point is from 110 to 130° C. For HDPE, the density is from >0.945 to 0.96 g/cm³, the melt flow index (190/2.16) is from 0.1 to 1 g/10 min, and the crystalline melting point is from 130 to 150° C.

The comonomers employed in polyethylenes are generally olefinic monomers, of which short-chain olefins having from 3 to 6 C atoms, in particular propylene and/or butylene, are preferred.

The above-mentioned polyethylenes are known per se from the prior art and have already been described as components of biaxially oriented polypropylene films. For the purposes of the present invention, HDPE is particularly preferred.

Suitable thermoplastic polyesters are the aromatic polyesters made from aromatic dicarboxylic acids and polyhydric alcohols that are known per se. Aromatic dicarboxylic acids are, for example, terephthalic acid, benzenedicarboxylic acid, naphthalene-2,6-dicarboxylic acid or isophthalic acid, and polyhydric alcohols are, for example, diethylene glycol, triethylene glycol, ethanediol or butanediols. Particular preference is given to polyesters made from ethylene glycol or butylene glycol and terephthalic acid, which are also known as PET or PBT.

In addition, copolyesters known per se, which are also known as PET G and are based on three different monomers, generally at least two different polyhydric alcohols and one dicarboxylic acid, can advantageously be employed. Copolyesters of this type which are particularly suitable for the purposes of the present invention are described in EP 0 418 836, page 2, line 42, to page 3, line 1. This description is expressly incorporated herein by way of reference.

The thermoplastic polymer II selected is particularly advantageously a polypropylene, polyethylene or polyester, which, as is known, can be employed for the production of or in a biaxially oriented film comprising the said polymers.

In a further embodiment, inorganic additives may be present in the base layer instead of the polymers II or in addition to these polymers II. For the purposes of the present invention, inorganic additives include materials such as, for example, aluminium oxide, aluminium sulphate, barium sulphate, calcium carbonate, magnesium carbonate, silicates, such as aluminium silicate (kaolin clay) and magnesium silicate (talc), silicon dioxide and titanium dioxide, of which calcium carbonate, silicon dioxide, titanium dioxide and barium sulphate are preferably employed. In general, the mean particle diameter of the inorganic additives is from 0.1 to 6 μm, preferably from 1.0 to 5 μm. These inorganic additives are known per se from the prior art and are used, for example, in polypropylene films as whitening or colouring pigments or vacuole-initiating fillers. In the course of the present invention, no formation of vacuoles by these inorganic additives in a polymer matrix of PLA has been observed. Surprisingly, however, these substances in the polymer matrix of PLA contribute to the good and controllable tear behaviour of the film.

In addition to the said polymers I and II or the inorganic additives, the base layer may comprise conventional additives, such as neutralizers, stabilizers, antistatics and/or lubricants, in effective amounts in each case.

The film optionally includes top layer(s) of polyhydroxycarboxylic acids on one or both sides, applied to the base layer or to additional interlayers. The top layer(s) generally comprises/comprise from 85 to 100% by weight of polyhydroxy acids, preferably from 90 to <100% by weight of polyhydroxy acids, and from 0 to 15% by weight or from >0 to 10% by weight of conventional additives, in each case based on the weight of the top layer(s).

Examples of suitable polyhydroxy acids in the top layer(s) are polylactic acids built up exclusively from lactic acid units. Particular preference is given here to PLA polymers which comprise 80-100% by weight of L-lactic acid units, corresponding to from 0 to 20% by weight of D-lactic acid units. In order to reduce the crystallinity, even higher concentrations of D-lactic acid units may also be present as comonomer. If desired, the polylactic acid may comprise additional polyhydroxy acid units other than lactic acid as comonomer, as described for the base layer.

For the top layer(s), lactic acid polymers having a melting point of from 110 to 170° C., preferably from 125 to 165° C., and a melt flow index (measurement DIN 53 735 at a load of 2.16 N and 190° C.) of from 1 to 50 g/10 min, preferably from 1 to 30 g/10 min, are preferred. The molecular weight of the PLA is in the range from at least 10,000 to 500,000 (number average), preferably from 50,000 to 300,000 (number average). The glass transition temperature Tg is in a range from 40 to 100° C., preferably from 40 to 80° C.

In a further embodiment, the top layer(s) can also be built up from the mixtures of polymers I based on hydroxycarboxylic acid and thermoplastic polymers II and/or inorganic additives described above for the base layer. In principle, all mixtures of polymer I and II and/or inorganic additives described above for the base layer are also suitable for the top layer.

If desired, the additives described above for the base layer, such as antistatics, neutralizers, lubricants and/or stabilizers, and, if desired, additionally antiblocking agents may be added to the top layer(s).

The thickness of the top layer(s) is greater than 0.1 μm and is preferably in the range from 0.1 to 5 μm, in particular from 0.5 to 3 μm, where top layers on both sides may have identical or different thicknesses. The total thickness of the film according to the invention can vary and is preferably from 5 to 80 μm, in particular from 8 to 50 μm, with the base layer in multilayered embodiments making up from about 40 to 98% of the total film thickness. For particularly environmentally friendly packaging, it is preferred to employ particularly thin films having a thickness of from 5 to 20 μm, preferably 5-15 μm. Surprisingly, the films having this thickness still exhibit the desired tear behaviour.

The single-layered or multilayered biaxially oriented film is produced by the stenter process, which is known per se. In this process, the melts corresponding to the individual layers of the film are extruded or coextruded through a flat-film die, the resultant film is taken off over one or more roll(s) for solidification, the film is subsequently stretched (oriented), and the stretched film is heat-set.

Biaxial stretching (orientation) is carried out sequentially, with consecutive biaxial stretching, in which stretching is carried out first longitudinally (in the machine direction) and then transversely (perpendicular to the machine direction), being preferred. It has been found that simultaneous stretching in the two directions easily results in tears in the film or even tearing-off. A simultaneous process or blowing process for the production of the film is therefore generally not suitable. The film production is described further using the example of flat-film extrusion with subsequent sequential stretching.

In this process, as usual in the extrusion process, the polymer or polymer mixture of the individual layers is compressed and liquefied in an extruder, with it being possible for any additives added already to be present in the polymer or in the polymer mixture. If desired, the thermoplastic polymers II and/or the inorganic additives may be incorporated into the base layer as a masterbatch. These masterbatches are based on PLA and comprise thermoplastic polymer, such as PP, PE or PET, or the inorganic additives in a concentration of from 5 to 40% by weight, based on the batch. In a further embodiment of the process, the components of the mixture in the corresponding concentrations are mixed by melt extrusion in a separate granulation step.

The melt(s) is (are) then forced through a flat-film die (slot die), and the extruded film is taken off over one or more take-off rolls at a temperature of from 10 to 100° C., preferably from 20 to 60° C., during which it cools and solidifies.

The resultant film is then stretched longitudinally and transversely to the extrusion direction, which results in orientation of the molecule chains. The longitudinal stretching is preferably carried out at a temperature of from 50 to 150° C., advantageously with the aid of two rolls running at different speeds corresponding to the target stretching ratio, and the transverse stretching is preferably carried out at a temperature of from 50 to 150° C. with the aid of a corresponding tenter frame. The longitudinal stretching ratios are in the range from 1.5 to 6, preferably from 2 to 5. The transverse stretching ratios are in the range from 3 to 10, preferably from 4 to 7. It has been found that the addition of thermoplastic polymer II and/or inorganic additives enables the use of higher longitudinal and transverse stretching ratios compared with a PLA film without such additives.

The stretching of the film is followed by heat-setting (heat treatment) thereof, in which the film is held at a temperature of from 60 to 150° C. for from about 0.1 to 10 s. The film is subsequently wound up in a conventional manner using a wind-up device.

The invention is explained below with reference to working examples.

### EXAMPLE 1

A single-layered film having a thickness of 15 μm was produced by extrusion and subsequent stepwise orientation in the longitudinal and transverse directions. The layer was built up from about 99% of a polylactic acid having a melting point of 135° C. and a melt flow index of about 3 g/10 min and a glass transition temperature of about 60° C. and about 1% of a propylene homopolymer (trade name Escorene PP4352F1) and comprised stabilizers and neutralizers in conventional amounts. The production conditions in the individual process steps were as follows:

| Extrusion: | Temperatures Base layer: | 195° C. |
|---|---|---|
| | Temperature of the take-off roll: | 50° C. |
| Longitudinal | Temperature: | 68° C. |
| stretching: | Longitudinal stretching ratio: | 4.0 |
| Transverse stretching: | Temperature: | 88° C. |
| | Transverse stretching ratio (effective): | 5.5 |
| Setting: | Temperature: | 100° C. |
| | Convergence: | 5% |

### EXAMPLE 2

A single-layered film having a thickness of 15 μm was produced by extrusion and subsequent stepwise orientation in the longitudinal and transverse directions as described in Example 1. In contrast with Example 1, the layer was built up from about 99% of a polylactic acid having a melting point of 135° C. and a melt flow index of about 3 g/10 min and a glass transition temperature of about 60° C. and about 1% of a polyethylene (trade name LDPE PG 7004, produced by Dow) and comprised stabilizers and neutralizers in conventional amounts.

### EXAMPLE 3

A single-layered film having a thickness of 15 μm was produced by extrusion and subsequent stepwise orientation in the longitudinal and transverse directions as described in Example 1. In contrast with Example 1, the layer was built up from about 99% of a polylactic acid having a melting point of 135° C. and a melt flow index of about 3 g/10 min and a glass transition temperature of about 60° C. and about 1% of a polyester (Eastar PETG6763, produced by Eastman) and comprised stabilizers and neutralizers in conventional amounts.

### EXAMPLE 4

A three-layered film having a symmetrical structure and a total thickness of 20 μm was produced by coextrusion and subsequent stepwise orientation in the longitudinal and transverse directions. The top layers each had a thickness of 1.5 μm. The base layer was built up as described in Example 1 from about 99% of a polylactic acid having a melting point of 135° C. and a melt flow index of about 3 g/10 min and a glass transition temperature of about 60° C. and about 1% of a polypropylene (trade name Escorene PP4352F1) and comprised stabilizers and neutralizers in conventional amounts. The top layers were built up from about 99% of a polylactic acid having a melting point of 135° C. and a melt flow index of about 3 g/10 min and a glass transition temperature of about 60° C. and about 1% of a polypropylene (trade name Escorene PP4352F1) and comprised stabilizers and neutralizers as well as lubricants and antistatics in conventional amounts.

The production conditions in the individual process steps were as follows:

| Extrusion: | Temperatures Base layer: | 195° C. |
|---|---|---|
| | Top layers: | 175° C. |
| | Temperature of the take-off roll: | 50° C. |
| Longitudinal | Temperature: | 68° C. |
| stretching: | Longitudinal stretching ratio: | 3 |
| Transverse stretching: | Temperature: | 85° C. |
| | Transverse stretching ratio (effective): | 5.5 |
| Setting: | Temperature: | 75° C. |
| | Convergence: | 5% |

### EXAMPLE 5

A three-layered film having a symmetrical structure and a total thickness of 20 μm was produced by coextrusion and subsequent stepwise orientation in the longitudinal and transverse directions. The top layers each had a thickness of 1.5 μm. The base layer was built up from about 99% of a polylactic acid having a melting point of 135° C. and a melt flow index of about 3 g/10 min and a glass transition temperature of about 60° C. and about 0.5% of a polypropylene (trade name Escorene PP4352F1) and about 0.5% of a polyester (trade name Eastar PETG6763, produced by Eastman) and comprised stabilizers and neutralizers as well as lubricants and antistatics in conventional amounts.

The production conditions in the individual process steps were as follows:

| Extrusion: | Temperatures Base layer: | 195° C. |
|---|---|---|
| | Top layers: | 175° C. |
| | Temperature of the take-off roll: | 50° C. |
| Longitudinal | Temperature: | 68° C. |
| stretching: | Longitudinal stretching ratio: | 3 |
| Transverse stretching: | Temperature: | 85° C. |
| | Transverse stretching ratio (effective): | 5.5 |
| Setting: | Temperature: | 75° C. |
| | Convergence: | 5% |

1. Biaxially stretched film, characterized in that the film includes at least one base layer which comprises at least one polymer I comprising at least one hydroxycarboxylic acid and ≧0.1% by weight, based on the weight of the layer, of a thermoplastic polymer II which is different from the polymer I and/or inorganic additives.

2. Film according to claim 1, characterized in that the polymer I is a polylactic acid.

3. Film according to claim 1, characterized in that the polymer I is a polylactic acid which comprises 80-100% by weight of L-lactic acid units and from 0 to 20% by weight of D-lactic acid units or other polyhydroxycarboxylic acid units.

4. Film according to claim 1, characterized in that the thermoplastic polymer II is a propylene polymer, polyethylene polymer or a polyester.

5. Film according to claim 5, characterized in that the propylene polymer is a propylene homopolymer or propylene copolymer, and the polyethylene is an HDPE, an LDPE or an MDPE, and the polyester is a PET or a PBT.

6. Film according to claim 1, characterized in that the base layer comprises the polymer I in an amount of from 85 to 99.9% by weight, preferably from 90 to 99.5% by weight, and the polymer II and/or the inorganic additives in an amount of from 0.1 to 15% by weight, preferably from 0.5 to 10% by weight, in each case based on the layer.

7. Film according to claim 1, characterized in that the biaxially oriented film has a thickness of from 5 to 80 μm, preferably from 5 to 20 μm.

8. Use of a biaxially stretched film according to claim 1, for the production of packaging having controlled tear propagation behaviour.

9. Thread or tape produced from a film according to claim 1.

10. Use of a thread or tape according to claim 10 as tear-open thread or tear-open tape.
